(19) United States
(12) Patent Application Publication
(10) Pub. No.: US 2018/0178358 A1
(43) Pub. Date: Jun. 28, 2018

(54) SCREW ROPE FOR USE IN SUCCESSIVE SCREW CLAMPING MACHINE

(71) Applicant: MURO CORPORATION, Utsunomiya (JP)

(72) Inventors: Kunihiro Arai, Utsunomiya (JP); Tomiaki Ochiai, Utsunomiya (JP)

(73) Assignee: MURO CORPORATION, Utsunomiya (JP)

(21) Appl. No.: 15/841,969

(22) Filed: Dec. 14, 2017

(30) Foreign Application Priority Data
Dec. 22, 2016 (JP) 2016-249783

(51) Int. Cl. B25B 23/04

(52) U.S. Cl. CPC B25B 23/045

(57) ABSTRACT

A screw rope is configured to hold fixed portions of threaded parts of respective screws so as to be obliquely disposed at predetermined parallel intervals and at a predetermined inclination angle by a belt-shaped member which runs in a length direction and binding strips which are provided on the rear surface side of the belt-shaped member at predetermined intervals, to continuously form a guide groove on the front surface side of the belt-shaped member along a length direction thereof, to dispose many upper recessed parts at a position above the guide groove in a scattered state and over the entire length on the front surface side of the belt-shaped member and to dispose many lower recessed parts at a position under the guide groove in the scattered state and over the entire length.

### TECHNICAL FIELD

The present invention relates to a screw rope (commercially identified by the registered trademark “VISROPE”) for use in a successive screw clamping machine, and describing in detail, relates to the screw rope for use in the successive screw clamping machine configured to suppress a limitation on coupling pitch of the screws caused by a difference in diameter among screw heads, to suppress a restriction on shapes of target screw heads (the screw heads to be handled in the above-mentioned successive screw clamping machine) regardless of the outer shape, the thickness and so forth of each screw head and thereby to make it possible to increase the number of kinds of target screws used and to perform driving targeting on, for example, a tip hole position of a clamped member, when the successive screw clamping machine is used for clamping by using the screw rope with many screws being mounted.

### BACKGROUND ART

There is proposed a successive screw clamping machine of the type of successively clamping the screws in order to fix plate materials such as, for example, a wood plate, a metal plate, a gypsum board and so forth to a floor surface or a wall surface.

There is proposed a successive screw clamping machine which is configured such that a driver is built in a clamping machine body with a grip handle being formed, a screw clamping bit is detachably coupled to the driver, a screw feeding mechanism body is attached to a front part of the clamping machine body so as to freely slide in a front-back direction, the bit is rotatably inserted into the screw feeding mechanism body, a clamping depth adjusting mechanism for adjusting the clamping depth of the screw by the bit is configured on the clamping machine body, a screw feeding machine which sequentially feeds respective screws on a screw rope that many screws are attached to a belt-shaped member side by side to a position of a clamping action by the bit in linkage with forth-back sliding movement of the screw feeding mechanism body in association with a clamping operation by the bit is configured on the screw feeding mechanism body, and a leading end block that an abutment surface is disposed in a projected state is configured on the screw feeding mechanism body so as to be fixed to a desirable position in the front-back direction relative to the screw feeding mechanism body, for example, in Japanese Unexamined Patent Application Publication No. Hei9-136269.

In case of a screw rope 101 in the successive screw clamping machine disclosed in Japanese Unexamined Patent Application Publication No. Hei9-136269, as illustrated in FIG. 17 and FIG. 18, the screw rope 102 is configured by a simple structure that many screws S are held side by side by a belt-shaped member 102 and binding strips 103 on a side surface of the belt-shaped member 102 at predetermined intervals and in arrangement orthogonal to the belt-shaped member 102. In addition, the screw feeding mechanism of the successive screw clamping machine disclosed in Japanese Unexamined Patent Application Publication No. Hei9-136269 is configured so as to feed out the respective screw S held by the screw rope 101 to the clamping action position while sequentially moving the screws S in parallel in linkage with forth-back sliding movement of the screw feeding mechanism body in association with the clamping operation by the bit.

In most of other various successive screw clamping machines which are being practically used now, configurations of screw ropes thereof and configurations of screw feeding mechanisms thereof are the same as those of the above-mentioned successive screw clamping machine disclosed in Japanese Unexamined Patent Application Publication No. Hei9-136269.

Under the existing circumstances, in a case where a specific successive screw clamping machine is used, it is requested to set the coupling pitch of the screws in conformity with diameters of screw heads in order to allow use of the screw rope with many screws being mounted in the clamping machine, then when the coupling pitch of the screws is fixed, the number of the kinds of the screws coping with this fixed coupling pitch is limited and when the respective screws are guided depending on the shapes of screw heads, there is a restriction on the shape of the screw head used and the number of the kinds of the screws used is more limited, further, although even the screw rope having an ever adopted configuration is used for application for clamping a member originally having no specific hole to be clamped, it is difficult to perform driving, targeting on, for example, the position of a tip hole in a clamped member in the screw rope having the ever adopted configuration.

### CITATION LIST

### Patent Literature

Patent Literature 1: Japanese Unexamined Patent Application Publication No. Hei9-136269

### SUMMARY OF INVENTION

### Problem to be Solved by the Invention

The present invention has been made in view of the above mentioned existing circumstances and aims to provide a screw rope for use in the successive screw clamping machine configured to suppress the limitation on coupling pitch of the screws caused by the difference in diameter among screw heads, to suppress the restriction on shapes of the target screw heads (the screw heads to be handled in the above-mentioned successive screw clamping machine) regardless of the outer shape, the thickness and so forth of each screw head and thereby to make it possible to increase the number of kinds of target screws used and to perform driving targeting on, for example, the tip hole position of the clamped member, when the successive screw clamping machine is used for clamping by using the screw rope with many screws being mounted.

### Means for Solving Problem

According to one embodiment of the present invention, there is provided a screw rope for use in a successive screw clamping machine including a grip unit in which a screw clamping bit is disposed so as to project therefrom and which rotationally drives the bit by switch operation and a clutch, a screw clamping machine body unit which is disposed under the grip unit and supports the grip unit to be movable downward and upward, includes a feeder block which makes a leading end of the bit face a clamping action position and is disposed on the lateral side of the clamping action position and a guide cover which is disposed so as to face the feeder block thereby to guide a plurality of screws supported by the screw rope to the clamping action position side between the feeder block and the guide cover and successively clamp the screws to underlying clamping object spots, and also includes a guide projection part for guidance of the screw rope which is formed on one side of a wall surface of the guide cover along which the screw rope is guided and is formed into an inclined shape which lowers toward the side of a feeding destination of the screw rope, and a magazine unit which feeds in turn many screws held by the screw rope, in which the screw rope is configured to hold fixed portions of threaded parts of the respective screws so as to be obliquely disposed at predetermined parallel intervals and at a predetermined inclination angle corresponding to an inclination angle of the guide projection part by a belt-shaped member which runs in a length direction and binding strips which are provided on the rear surface side of the belt-shaped member at predetermined intervals and to continuously form a guide groove on the front surface side of the belt-shaped member along a length direction thereof, and the screw rope is configured such that when the screw rope is used, the screws are guided to the clamping action position in turn in a manner that height positions of screw heads of the respective screws are lowered as the screws approach the clamping action position side of the bit while keeping the screw rope in an inclined state and keeping the respective screws in vertical states by engagement of the guide projection part of the guide cover with the geode groove in the screw rope.

### Effect of the Invention

According to the invention defined in claim 1 or 2, it is possible to realize and provide the screw rope for use in the successive screw clamping machine which is able to function as the screw rope for the specific successive screw clamping machine and is makes it possible to reduce the restrictions and so forth on the size of the head diameter and the shape of each screw and to increase freedom of selection of the kind of the screw used.

According to the invention defined in claim 3, the same effect as that of the invention defined in claim 1 or 2 is obtained. In addition, since many recessed parts are disposed at the position other than that of the guide grove in the length direction of the belt-shaped member in the scattered state and over the entire length, bending balance of the guide groove when winding the screw rope into a coiled shape becomes favorable and consequently it is possible to realize and provide the screw rope for use in the successive screw clamping machine which makes it possible to hold many screws in a favorable state as a whole and in a massive shape.

According to the invention defined in claim 4, the same effect as that of the invention defined in claim 1 or 2 is obtained. In addition, the same effect as that of the invention defined in claim 3 is obtained by using the belt-shaped member that both of an upper recessed part and a lower recessed part are provided on both sides of the guide groove. That is, the bending balance between the upper and lower sides of the guide groove when winding the screw rope into the coiled shape becomes favorable and consequently it is possible to realize and provide the screw rope for use in the successive screw clamping machine which makes it possible to hold many screws in the favorable state as a whole and in the massive shape.

### BRIEF DESCRIPTION OF DRAWINGS

FIG. 1 is a schematic perspective view illustrating one example of a general configuration of a successive screw clamping machine in which a screw rope according to one embodiment of the present invention is used, viewed from the front surface side thereof;

FIG. 2 is a schematic perspective view illustrating one example of the general configuration of the successive screw clamping machine in which the screw rope according to the present embodiment is used, viewed from the side surface side thereof;

FIG. 3 is a schematic perspective view illustrating one example of the general configuration of the successive screw clamping machine in which the screw rope according to the present embodiment is used, viewed from the upper surface side thereof;

FIG. 4 is a schematic enlarged diagram illustrating one example of a part A in FIG. 1;

FIG. 5 is a partial enlarged diagram illustrating one example of a screw clamping machine body unit, viewed from the arrow C side in FIG. 1;

FIG. 6 is a schematic enlarged diagram illustrating one example of a part B in FIG. 2;

FIG. 7 is a schematic enlarged front view illustrating one example of a guide cover which configures the screw clamping machine body unit in which the screw rope according to the present embodiment is used;

FIG. 8 is a schematic enlarged rear view illustrating one example of the guide cover which configures the screw clamping machine body unit in which the screw rope according to the present embodiment is used;

FIG. 9 is a schematic enlarged side view illustrating one example of the guide cover which configures the screw clamping machine body unit in which the screw rope according to the present embodiment is used;

FIG. 10 is schematic plan view and side view illustrating one example of part of the screw rope which holds the screws according to the present embodiment;

FIG. 11 is a side view illustrating one example of part of the screw rope which holds the screws according to the present embodiment, illustrating an example of a case where screws which are large in head diameter are used;

FIG. 12 is a partial enlarged sectional diagram illustrating one example of the screw rope which holds the screws according to the present embodiment, viewed from the upper surface side of the screw rope;

FIG. 13 is a partial enlarged sectional diagram illustrating one example of the screw rope which holds the screws according to the present embodiment, viewed from the lower surface side of the screw rope;

FIG. 14 is a schematic perspective view illustrating one example of a state where the screw rope which holds the screws according to the present embodiment is wound into a coiled shape;

FIG. 15 is a partial enlarged perspective view illustrating one example of a state where the screw rope according to the present embodiment is fed into and discharged from a clamping action position by the screw clamping machine body unit of the successive screw clamping machine in which the screw rope according to the present embodiment is used;

FIG. 16 is a reference diagram illustrating one example of a state where the screw rope is fed into and discharged from the clamping action position by the screw clamping machine main unit of the successive screw clamping machine in which the screw rope according to the present embodiment is used and a state of performing driving targeting on a tip hole position of a clamped member by using the successive screw clamping machine concerned;

FIG. 17 is a schematic plan view illustrating part of an existing screw rope which holds screws; and

FIG. 18 is a schematic sectional diagram illustrating part of the existing screw rope which holds the screws.

### DESCRIPTION OF THE INVENTION

The present invention provides a screw rope for use in successive screw clamping machine which is configured to suppress the limitation on coupling pitch of the screws caused by the difference in diameter among screw heads, to suppress the restriction on shapes of the target screw heads of the subject successive screw clamping machine regardless of the outer shape, the thickness and so forth of each screw head and thereby to make it possible to increase the number of configurations and sizes of target screws that can be driven thereby. For example, when the successive screw clamping machine is used for clamping by using the screw rope with many screws being mounted, a tip hole position of a clamped member imparts a configuration wherein the grip unit in which the screw clamping bit is disposed projects therefrom and rotationally drives the bit by switch operation employing a clutch so that the screw clamping machine body unit disposed under and thus supports the grip unit so it is movable downward and upward. The present invention includes the feeder block at the leading end of the bit face disposed on the lateral side at a clamping position where clamping action is provided and a guide cover is disposed so as to face the feeder block to thereby guide the plurality of screws supported by the screw rope toward the clamping action position side between the feeder block and the guide cover and thereby successively clamp the screws to underlying clamping object spots. The present invention further includes the guide projection part for guidance of the screw rope which is formed on one side of the wall surface of the guide cover along which the screw rope is guided and is formed into the inclined shape which lowers toward the side of a feeding destination of the screw rope, and the magazine unit which feeds in turn many screws held by the screw rope, in which the screw rope is configured to hold the fixed portions of the threaded parts of the respective screws so as to be obliquely disposed at predetermined parallel intervals and at the predetermined inclination angle corresponding to the inclination angle of the guide projection part by the belt-shaped member which runs in the length direction and binding strips which are provided on the rear surface side of the belt-shaped member at predetermined intervals and to continuously form the guide groove on the front surface side of the belt-shaped member along the length direction thereof. Thus, the screw rope according to the present invention is configured such that the screws are guided to the clamping action position in turn in a manner that height positions of the screw heads of the respective screws are lowered as the screws approach the clamping action position side of the bit while keeping the screw rope in the inclined state and keeping the respective screws in the vertical states by engagement of the guide projection part of the guide cover with the geode groove in the screw rope.

### Embodiment

In the following, a screw rope for use in successive screw clamping machine according to one embodiment of the present invention will be described in detail with reference to the drawings.

A screw rope 6 according to the present embodiment is used in a successive screw clamping machine 1 which will be described in the following. The successive screw clamping machine 1 has the same configuration as the successive screw clamping machine which is disclosed in Japanese Patent Application No. 2016-090793 that the applicant of the present application has filed prior to application of the present invention. In the following, the successive screw clamping machine 1 will be described.

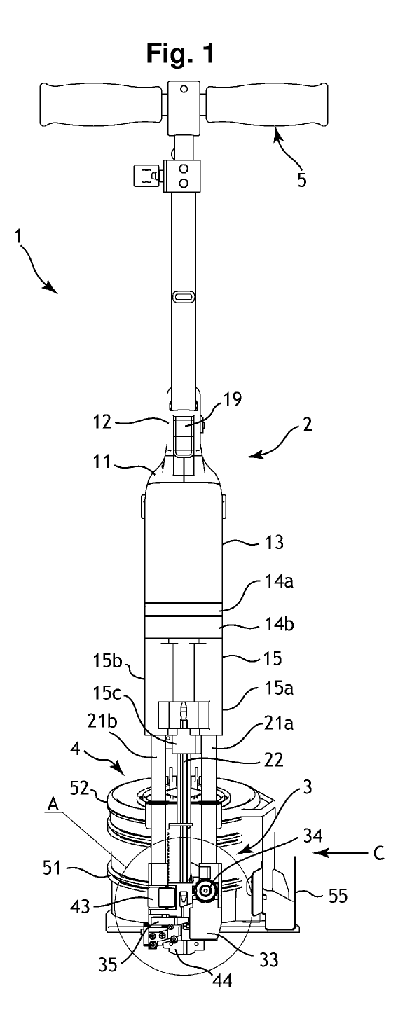

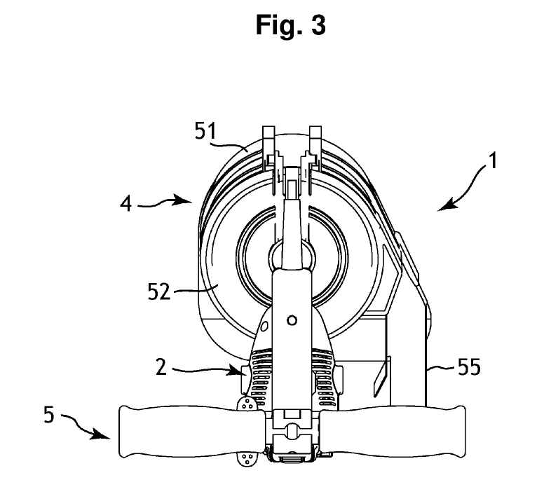

That is, the successive screw clamping machine 1 in which the later described screw rope 6 according to the present embodiment is used includes a grip unit 2 that an operator of the successive screw clamping machine 1 grips with one hand and pushes down in order to rotationally drive a bit 22 which is projected downward and to clamp a screw S to a target place, a screw clamping machine body unit 3 which is disposed under the grip unit 2 and clamps the screw S to the target place by utilizing rotation force by the bit 22, a magazine unit 4 which is detachably disposed on a rear part of the screw clamping machine body unit 3 and feeds in turn many screws S held by the screw rope 6 according to the present embodiment which will be described in detail later to the screw clamping machine body unit 3, and a handle unit 5 which is disposed above the grip unit 2 and is configured to be freely inserted into and removed from the grip unit 2 and to be adjustable in height and that the operator of the successive screw clamping machine 1 grips with both hands (or one hand) to operate it as illustrated in FIG. 1 to FIG. 3, and FIG. 14.

In the successive screw clamping machine 1, the handle unit 5 is not a requisite configuration and is configured to be freely attached to and detached from the upper part of the grid unit 2.

When using the successive screw clamping machine 1, whether the successive screw clamping machine 1 is used with the handle unit 5 being mounted or not is optional.

The bit 22 is a member corresponding to a driver in general tools and is configured by a shaft which is hexagonal in sectional shape. Engagement projection parts, each of which engages with an engagement groove such as, for example, a plus groove formed in a screw head, are formed on both ends of the bit 22 and a meshing groove is formed in the vicinity of each engagement projection part in a circumferential direction.

The grip unit 2 includes a handle cover 11 of a two-sheet structure of front and rear sheets which forms a space into which the operator inserts one hand and grips the grip unit 2, an end cover 12 which covers over the handle cover 11, a cylindrical housing 13 which is disposed under the handle cover 11, a first lower cover 14a and a second lower cover 14b which are additionally disposed in turn under the housing 13, a block head 15 which is further additionally disposed under the second lower cover 14b and so forth.

A trigger switch 16 which is used for stating or stopping rotation of a not illustrated rotational drive source which rotationally drives the bit 22 is disposed on the lower surface side of the end cover 12 and a direction lever 17 for rotating the rotational drive source forward or reversely is attached to a position next to the trigger switch 16.

The trigger switch 16 and the direction lever 17 are configured integrally with each other so as to prevent accidental switching between forward rotation and reverse rotation.

In addition, a handle unit insertion port 18 into which the lower-end side of the handle unit 5 is inserted is disposed on the front-part side of the end cover 12 and a handle unit lock lever 19 which fixes the handle unit 5 to the grip unit 2 itself or releases fixing of the handle unit 5 is disposed on the front part of the handle cover 11.

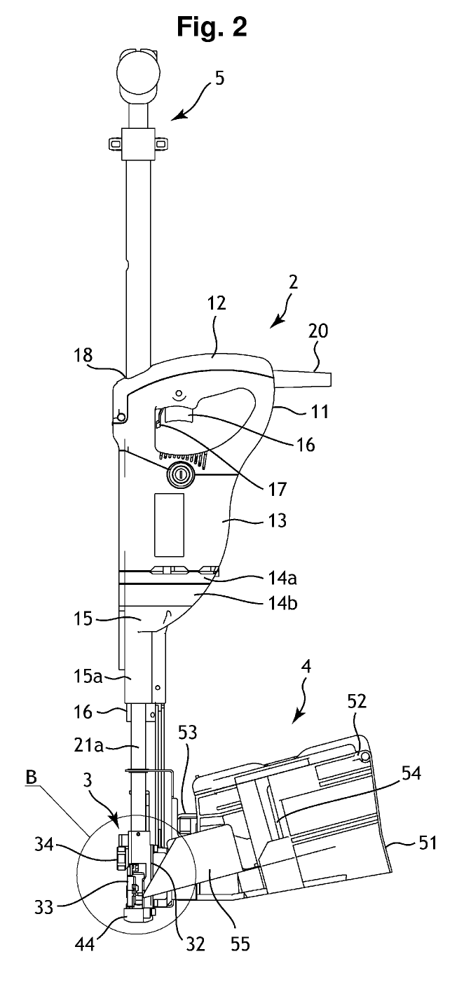

A code holding part 20 for holding a power source code (not illustrated) for supplying electric power requested for the operation of the successive screw clamping machine 1 is attached to the rear part of the end cover 12 of the grip unit 2 as illustrated in FIG. 2.

The block head 15 includes one pair of left and right guide pole insertion cylinders 15a and 15b which are juxtaposed and fit on outer circumferences of one pair of juxtaposed guide poles 21a and 21b which are interposed between the grip unit 2 and the screw clamping machine body unit 3 so as to be movable upward and downward and also includes a bit insertion cylinder 15c which is disposed on an intermediate part between positions under one pair of the guide pole insertion cylinders 15a and 15b and through which the bit 22 is inserted.

Then, the bit 22 the upper end part of which is held by the grip unit 2 is projected downward passing through the bit insertion cylinder 15c so as to make the lower end side of the bit 22 face the inside of the screw clamping machine body unit 3.

The screw clamping machine body unit 3 includes a box-shaped feeder block 32 which defines its external shape as a main constituent component and makes the leading end part of the bit 22 which is projected from the grip unit 2 and passes through the bit insertion cylinder 15c face a clamping action position in the feeder block 32.

One pair of guide pole receiving parts 32a and 32b to which lower end parts of the one pair of guide poles 21a and 21b which are inserted into the one pair of the guide pole insertion cylinders 15a and 15b of the block head 15 of the grip unit 2 and guide the block head 15, that is, downward and upward moving operations of the grip unit 2 are mounted are disposed on an upper surface part of the feeder block 32.

A feed lever manipulator, not illustrated in the drawings, whose upper end part is coupled with the block head 15 and whose lower end side faces the inside of the screw clamping machine body unit 3 is disposed between the grip unit 2 and the screw clamping machine body unit 3 and is engaged with feed lever, also not illustrated, which configures a screw feeding mechanism part 31 provided on the screw clamping machine body unit 3 such that the downward and upward moving operations of the grip unit 2 are performed in linkage with the operation of the screw feeding mechanism part 31 which will be described later.

In addition, the screw feeding mechanism part 31 which feeds the respective screws S attached to a belt-shaped member 7 of the screw rope 6 which is configured as described later and is supplied from the side part of the screw clamping machine body unit 3 into the clamping action position in linkage with the clamping operation by the screw clamping machine body unit 3 is incorporated into the screw clamping machine body unit 3.

The screw feeding mechanism part 31 includes the feeder block 32 and a guide cover 33 which attaches the screw rope 6 to the front-surface right side of the feeder block 32 such that the position relative to the feeder block 32 is finely adjusted by an adjustment dial 34 in the front-back direction (a depth direction of the feeder block 32) relative to the feeder block 32 thereby to make each screw S pass through a region between the feeder block 32 and the rear surface side of the guide cover 33 together with the screw rope 6 which will be described later and to guide the screw head of each screw S to the clamping action position.

In addition, though description of the detailed structure is omitted, the screw feeding mechanism part 31 includes the feed lever, a grip finger 35 illustrated in FIG. 1. a not illustrated link mechanism and so forth and operates the feed lever manipulator, the feed lever, the grip finger 35 and so forth in linkage with the downward and upward moving operations of the grip unit 2 thereby to perform guiding of each screw S held by the screw rope 6 to the clamping action position, holding of each screw S at the clamping action position and discharging of each empty portion of the screw rope 6 which is configured as described later after termination of the clamping operation.

A screw guide position adjustment mechanism part 41 which includes a screw guide 44 is disposed under the screw clamping machine body unit 3.

That is, the screw guide 44 which makes each screw S to be clamped pass through it and which brings the lower end surface of the screw S into abutment on a surface of the clamping target place to which the screw S is to be clamped is disposed under the screw clamping machine body unit 3.

Then, an adjuster plate 42 which stands upward vertically with its lower end part being coupled with the screw guide 44 is made to face the inside of the feeder block 32 such that positional adjustment of the adjuster plate 42 relative to the feeder block 32 and coupling and decoupling of the adjuster plate 42 to and from the feeder block 32 are made possible by manipulation of an adjust lever 43 provided in the feeder block 32 thereby to adjust the position of the screw guide 44 relative to the screw clamping machine body unit 3 (the position of the screw guide 44 which projects from the screw clamping machine body unit 3).

Next, the magazine unit 4 which feeds many screws S held by the screw rope 6 which is configured as described later in turn to a place between the feeder block 32 and the guide cover 33 of the screw clamping machine body unit 3 will be briefly described.

The magazine unit 4 is disposed on the rear surface side of the screw clamping machine body unit 3 and includes a bottomed cylindrical magazine body 51 which houses therein the screw rope 6 with many screws S being attached in a state of being wound into a circular coiled shape, a lid element 52 which is made openable and closable so as to cover an opening in the magazine body 51 and a mounting part 53 which is disposed on part of the outer circumference of the magazine body 51 and is configured such that the magazine body 51 and the lid element 52 are integrated with and are freely separated from the screw clamping machine body unit 3 as requested by detachably mounting the mounting part 53 to the rear surface side of the screw clamping machine body unit 3 as illustrated in FIG. 1 to FIG. 3 and FIG. 14.

Further, the magazine body 51 of the magazine unit 4 includes a draw-out port 54 for the screw rope 6 and a magazine side cover 55. Incidentally, the magazine body 51 may also have a configuration that the magazine side cover 55 is not included.

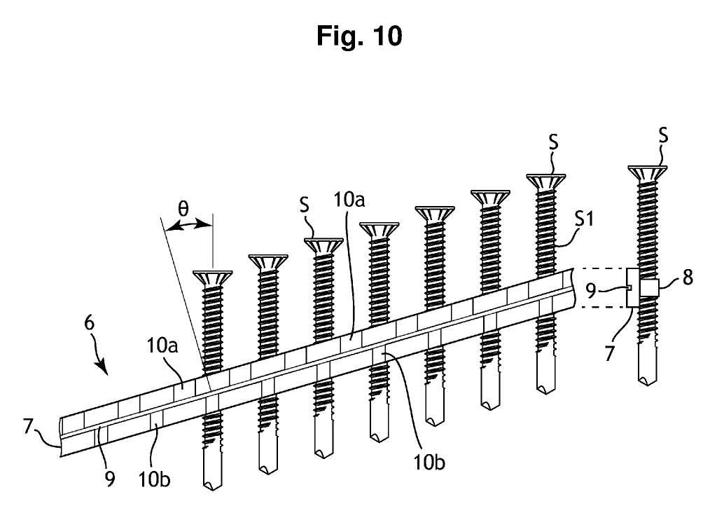

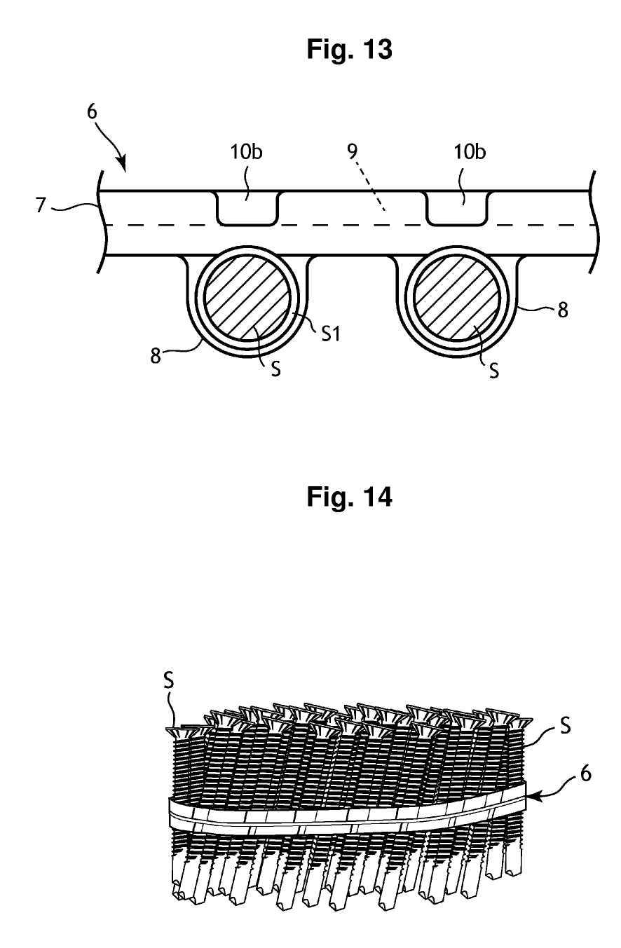

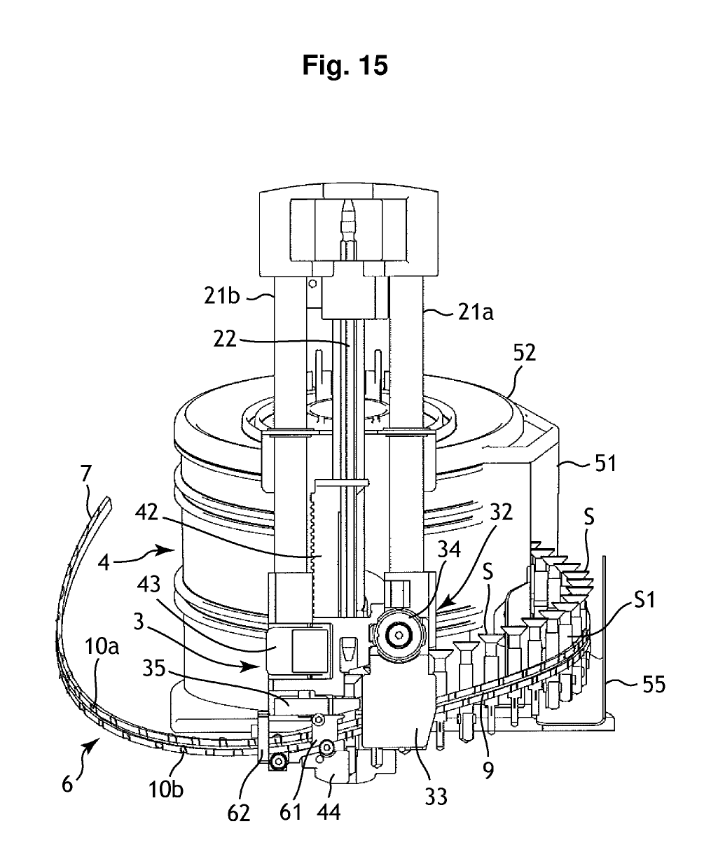

Next, a specific configuration of the screw rope 6 which holds the screws S will be described with reference to FIG. 10 to FIG. 13.

The screw rope 6 according to the present embodiment holds fixed portions of threaded parts 51 of the respective screws S so as to be obliquely disposed at predetermined parallel intervals and at a predetermined inclination angle θ by the square belt-shaped member 7 which runs in the length direction and the binding strips 8 which are disposed on the rear surface side of the belt-shaped member 7 at predetermined intervals.

In the screw rope 6, a groove 9 of a fixed width is continuously formed on the front surface side of the belt-shaped member 7 along the length direction of the belt-shaped member 7. Further, many upper recessed parts 10a are disposed in a scattered state and over the entire length of the belt-shaped member 7 at a position above the guide groove 9 and many lower recessed parts 10b are disposed in a scattered state and over the entire length of the belt-shaped member 7 at a position under the guide groove 9.

Incidentally, in the present invention, installation positions of the upper recessed parts 10a and the lower recessed parts 10b are not limited to those in the example illustrated in the drawings, many recessed parts may be disposed in the scattered state and over the entire length of the belt-shaped member 7 at a position or positions other than above and/or under the guide groove 9 in the length direction of the belt-shaped member 7 on the front surface side of the belt-shaped member 7 of the screw rope 6.

That is, the belt-shaped member 7 is formed into a roughly recessed shape in section (or end face).

The above-mentioned upper recessed parts 10a and lower recessed parts 10b are provided in order to adjust the bending balance of the screw rope 6 and the coiled shape of the screw rope 6 and either of them or both of them may be provided in the screw rope 6. However, as described later, it is found that more favorable bendability is obtained in a case where both of the upper recessed parts 10a and lower recessed parts 10b are provided than in other cases as described later.

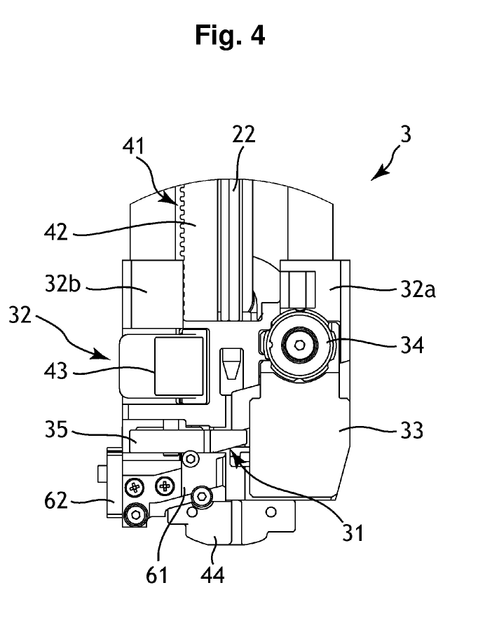

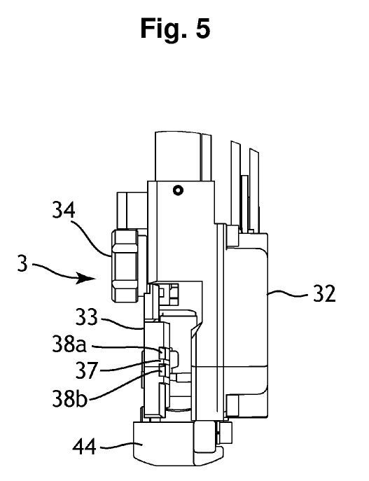

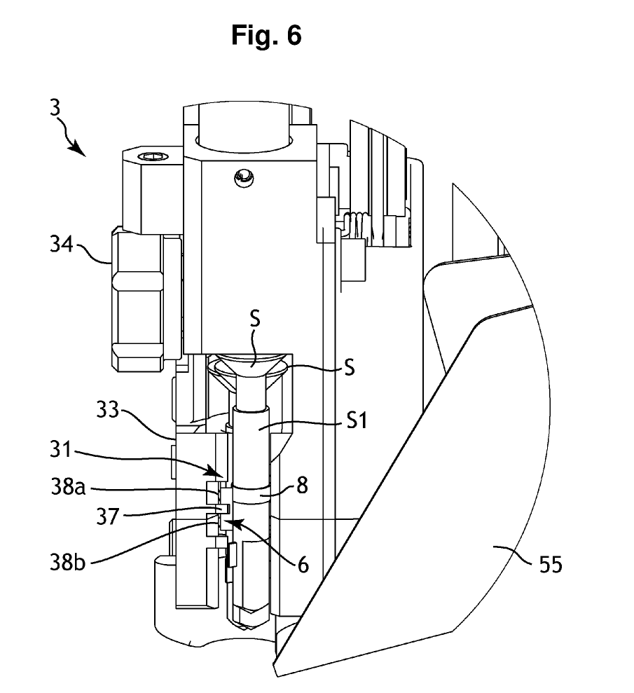

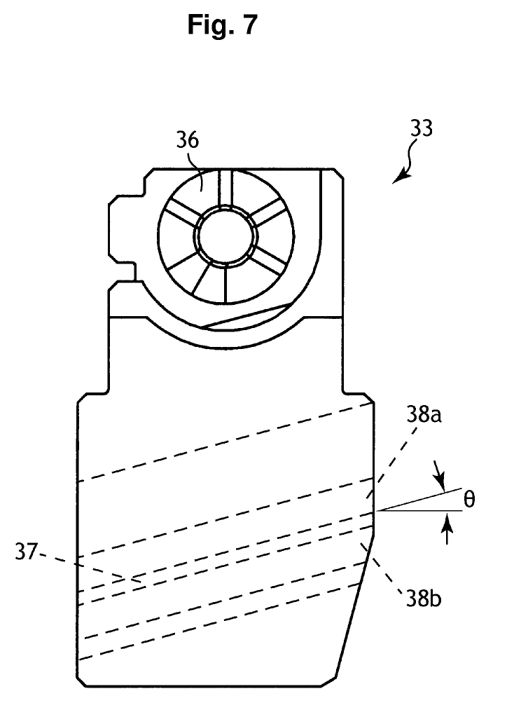

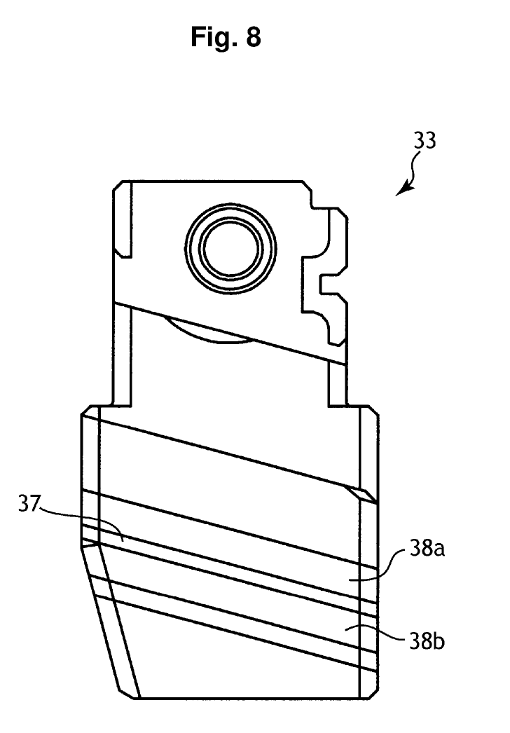

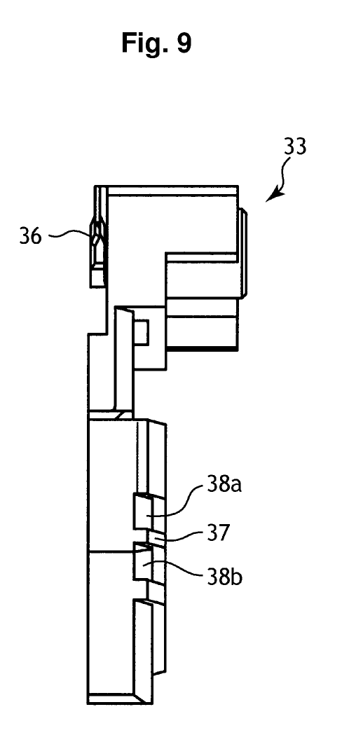

Next, the feeder block 32 and the guide lever 33 which configure the screw feeding mechanism part 31 of the screw clamping machine body unit 3 will be described in more detail with reference to FIG. 4 to FIG. 9.

The guide cover 33 includes a circular stepped cam 36 on its front upper part and is configured so as to finely adjust the position in the front-back direction (the thickness direction of the feeder block 32) relative to the feeder block 32 and thereby to adjust a gap dimension of a passing area for the screw rope 6 between the feeder block 32 and the guide cover 33 by mounting the adjustment dial 34 to the circular stepped cam 36 and rotationally operating the adjustment dial 34.

In addition, a guide projection part 37 which is formed into an inclined shape (the inclination angle θ) which lowers toward the side of a sending destination of the screw rope 6, engages with the guide groove 9 in the belt-shaped member 7 and guides the screw rope 6 in an inclined state and one pair of guide cover recessed parts 38a and 38b which are formed on both of the upper and lower sides of the guide projection part 37 also at the inclination angle θ are disposed on a wall surface of the guide cover 33 on the side along which the screw rope 6 is guided.

Then, the screw clamping machine body unit 3 is configured to guide the screw rope 6 which holds the screws S is guided in the inclined state in a state where the guide projection part 37 is engaged with the guide groove 9 in the belt-shaped member 7 and one pair of projected areas on the front surface side of the belt-shaped member 7 on the both sides of the guide groove 9 are respectively fitted into the one pair of the guide cover recessed parts 38a and 38b.

The screw clamping machine body unit 3 further includes a first empty screw rope guide strip 61 and a second empty screw rope guide strip 62 disposed on the front surface side of the feeder block 32 and on the side ahead of the clamping action position and is configured to guide each portion (each empty portion) of the screw rope 6 from which each screw S is detached after termination of the clamping operation by the first empty screw rope guide strip 61 and the second empty screw rope guide strip 62 and discharge each empty portion to the lateral side of the screw clamping machine body unit 3 as illustrated in FIG. 14.

Next, operational effects of the screw rope 6 according to the present embodiment and the successive screw clamping machine 1 using the screw rope 6 will be described by targeting mainly on the operational effect of the screw rope 6 itself, guiding of each screw S to the clamping action position by the successive screw clamping machine 1 when using the screw rope 6 and an operation of discharging the screw rope 6 with reference to FIG. 14.

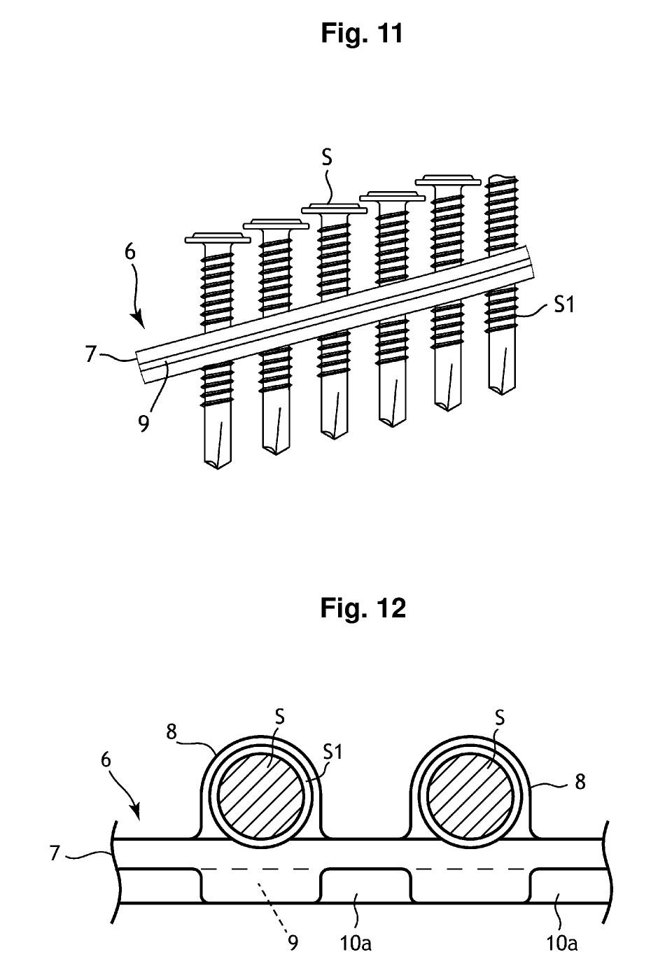

According to the screw rope 6 pertaining to the present embodiment which is configured as mentioned above, even in a case where a screw which is large in head diameter is used as the screw S, interference (contact) between heads of the adjacent screws S is eliminated by holding the respective screws S at predetermined parallel intervals so as to be obliquely disposed at the predetermined inclination angle θ. Thereby, even in a case where the head diameter of each screw S is more than or equal to, for example, the coupling pitch, it becomes possible to make the coupling pitch of the respective screws S on the screw rope 6 unchanged and it becomes possible to increase the freedom of selection of the kind of the screw S used. Incidentally, in a case where the screws which are large in, for example, head diameter are used, it becomes possible to smoothly use the respective screws S with no interference (contact) between the heads of the adjacent screws S by arranging the respective screws S in a manner that the screw heads mutually overlap as illustrated in FIG. 11.

In addition, it is found that in a case where the screw rope 6 having the above mentioned configuration that many screws S are successively held according to the present embodiment is wound into the coiled shape as illustrated in FIG. 14, the bending balance between the upper and lower sides of the guide groove 9 when winding the screw rope 6 into the coiled shape becomes favorable by using the screw rope of the type that both of the upper recessed parts 10a and the lower recessed part 10b are provided on the both sides of the guide groove 9 as mentioned above as the screw rope 6 and consequently it becomes possible to properly house many screws S held by the screw rope 6 in the magazine body 51 in the favorable state as a whole and in the massive shape and to smoothly draw out the screws S through the draw-out port 54.

Further, since the lower recessed parts 10b are successively disposed in the scattered state at the positions under the guide groove 9 of the screw rope 6, it is possible to control, for example, bending of the empty rope.

On the other hand, in a case where the screw rope of a structure that the lower recessed parts 10b or the upper recessed parts 10a are disposed only on the lower side or the upper side of the guide groove 9 is used, in the screw rope 6, the bending balance between the upper side and the lower side of the guide groove 9 become unfavorable, many screws S are gathered together into a conglomeration resembling an inverted or upright V shape in outer appearance making it difficult to appropriately house the screws S in the magazine body 51.

Use of the screw rope such that both upper recessed parts 10a and lower recessed parts 10b are disposed on the both sides of the guide groove 9 as described above as the screw rope 6 in this way facilitates shape control of the outer edges of many screws S while winding the screw rope 6 itself into the coiled shape.

In addition, according to the successive screw clamping machine 1 using the screw rope 6 according to the present embodiment, only when the screw rope 6 of the above-mentioned configuration is used, it is possible to guide the screws S in turn to the clamping action position in a manner that the height positions of the screw heads of the respective screws S are gradually lowered as they approach the clamping action position side of the bit 22 while keeping the screw rope 6 in the inclined state and keeping each screw S in the vertical state by engagement of the guide projection part 37 of the guide cover 33 with the guide groove 9 in the screw rope 6 and to smoothly discharge the portions from which the screws S are detached in turn to the lateral side of the clamping action position while guiding the portions by the first empty screw rope guide strip 61 and the second empty screw rope guide strip 62 without bringing them into contact with the upper surface of the clamping target place after termination of the operation of clamping each screw S as illustrated in FIG. 14.

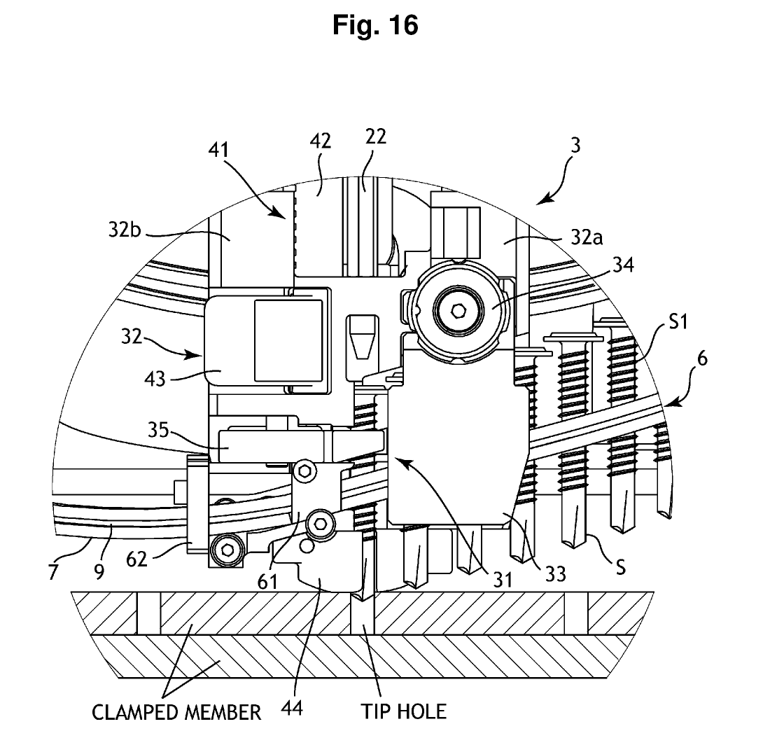

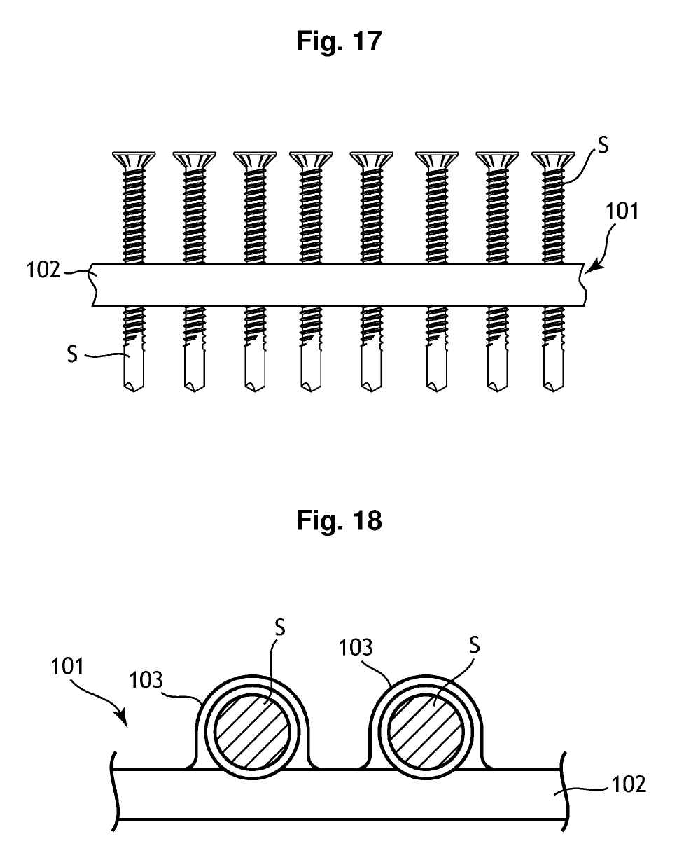

Still further, according to the successive crew clamping machine 1 using the screw rope 6 of the presently described embodiment, it becomes possible drive targeting on, for example, the tip hole position of the clamped member as illustrated in FIG. 16.

According to the screw rope 6 pertaining to the present embodiment and the successive screw clamping machine 1 using the screw rope 6, unification of a combination of the successive screw clamping machine 1 with the screw rope 6 and thereby it becomes possible to realize and provide the screw rope 6 which is allowed to be used only in this successive screw clamping machine 1 for certain successive screw clamping work and to realize and provide the successive screw clamping machine 1 which is able to execute the successive screw clamping work only in a case where the screw rope 6 concerned is used.

### INDUSTRIAL APPLICABILITY

The screw rope 6 according to the embodiment of the present invention is favorably applicable as the screw rope for use in the successive screw clamping machine used for work of clamping screws to structure materials such as floor surfaces and so forth of truck beds, work of clamping screws to structure materials which configure floors and so forth of construct products such as buildings, houses and so forth and work of clamping screws to structure materials such as floors and so forth of ships and so forth.

### REFERENCE COMPONENT NUMBERS LIST

1 successive screw clamping machine
2 grip unit
3 screw clamping machine body unit
4 magazine unit
5 handle unit
6 screw rope
7 belt-shaped member
8 binding strip
9 groove
10a upper recessed part
10b lower recessed part
11 handle cover
12 end cover
13 housing
14a first lower cover
14b second lower cover
15 block head
15a guide pole insertion cylinder
15b guide pole insertion cylinder
15c bit insertion cylinder
16 trigger switch
17 direction lever
18 handle unit insertion port
19 handle unit lock lever
20 code holding part
21a guide pole
21b guide pole
22 bit
31 screw feeding mechanism part
32 feeder block
32a guide pole receiving part
32b guide pole receiving part
33 guide cover
34 adjustment dial
35 grip finger
36 circular stepped cam
37 guide projection part
38a guide cover recessed part
38b guide cover recessed part
41 screw guide position adjustment mechanism part
42 adjuster plate
43 adjust lever
44 screw guide
51 magazine body
52 lid element
53 mounting part
54 draw-out port
55 magazine side cover
61 first empty screw rope guide strip
62 second empty screw rope guide strip
S screw
S1 threaded part

What is claimed is:

1. A screw rope for use in a successive screw clamping machine which includes
a grip unit in which a screw clamping bit is disposed so as to project therefrom and which rotationally drives the bit by switch operation and a clutch, a screw clamping machine body unit which includes a feeder block which makes a leading end of the bit face a clamping action position and is disposed on the lateral side of the clamping action position and a guide cover which is disposed so as to face the feeder block and also includes a guide projection part for guidance of a screw rope which is formed into an inclined shape and a magazine unit which feeds in turn many screws held by the screw rope, wherein
the screw rope is configured to hold fixed portions of threaded parts of the respective screws so as to be obliquely disposed at predetermined parallel intervals and at a predetermined inclination angle corresponding to an inclination angle of the guide projection part by a belt-shaped member which runs in a length direction and binding strips which are provided on the rear surface side of the belt-shaped member at predetermined intervals and to continuously form a guide groove on the front surface side of the belt-shaped member along a length direction thereof, and
the screw rope is configured such that when the screw rope is used, the screws are guided to the clamping action position in turn in a manner that height positions of screw heads of the respective screws are lowered as the screws approach the clamping action position side of the bit while keeping the screw rope in an inclined state and keeping the respective screws in vertical states by engagement of the guide projection part of the guide cover with the geode groove in the screw rope.

2. A screw rope for use in a successive screw clamping machine which includes a grip unit in which a screw clamping bit is disposed so as to project therefrom and which rotationally drives the bit by switch operation and a clutch, a screw clamping machine body unit which is disposed under the grip unit and supports the grip unit to be movable downward and upward, includes a feeder block which makes a leading end of the bit face a clamping action position and is disposed on the lateral side of the clamping action position and a guide cover which is disposed so as to face the feeder block thereby to guide a plurality of screws supported by the screw rope to the clamping action position side between the feeder block and the guide cover and successively clamp the screws to underlying clamping object spots, and also includes a guide projection part for guidance of the screw rope which is formed on one side of a wall surface of the guide cover along which the screw rope is guided and is formed into an inclined shape which lowers toward the side of a feeding destination of the screw rope, and a magazine unit which feeds in turn many screws held by the screw rope, wherein
the screw rope is configured to hold fixed portions of threaded parts of the respective screws so as to be obliquely disposed at predetermined parallel intervals and at a predetermined inclination angle corresponding to an inclination angle of the guide projection part by a belt-shaped member which runs in a length direction and binding strips which are provided on the rear surface side of the belt-shaped member at predetermined intervals and to continuously form a guide groove on the front surface side of the belt-shaped member along a length direction thereof, and
the screw rope is configured such that when the screw rope is used, the screws are guided to the clamping action position in turn in a manner that height positions of screw heads of the respective screws are lowered as the screws approach the clamping action position side of the bit while keeping the screw rope in an inclined state and keeping the respective screws in vertical states by engagement of the guide projection part of the guide cover with the geode groove in the screw rope.

3. The screw rope according to claim 1, wherein
many recessed parts are provided in a scattered state and over the entire length on the front surface side of the belt-shaped member of the screw rope at a position other than that of the guide groove in a length direction of the belt-shaped member.

4. The screw rope according to claim 1, wherein
many recessed parts are provided in a scattered state and over the entire length on the front surface side of the belt-shaped member of the screw rope in a length direction of the belt-shaped member at both of a position above the guide groove and corresponding to a position between the adjacent binding strips on the rear surface side thereof and a position under the guide groove and corresponding to the position of each binding strip on the rear surface side thereof.
